(19) United States
(12) Patent Application Publication
(10) Pub. No.: US 2026/0098153 A1
(43) Pub. Date: Apr. 9, 2026

(54) NANOPARTICLE INFUSED POLYMER FOR FIREARM COMPONENTS SUBJECTED TO HIGH WEAR

(71) Applicant: Sturm, Ruger & Company, Inc., Southport, CT (US)

(72) Inventors: Tod Douglas Boretto, Farmington, CT (US); Gary Hamilton, South Windsor, CT (US)

(73) Assignee: Sturm, Ruger & Company, Inc., Southport, CT (US)

(21) Appl. No.: 19/349,080

(22) Filed: Oct. 3, 2025

Related U.S. Application Data
(60) Provisional application No. 63/703,039, filed on Oct. 3, 2024.

(51) Int. Cl. C08L 75/04; B29C 45/00; B29C 64/10; B29L 31/00; B33Y 70/10; C08K 3/04; C08K 3/36; C08K 7/06; C08K 7/10; C08K 7/14; C08K 7/18; C08L 77/02

(52) U.S. Cl. CPC C08L 75/04; B29C 45/0001; B29C 45/0005; B29C 64/10; C08K 3/04; C08K 3/36; C08K 7/06; C08K 7/10; C08K 7/14; C08K 7/18; C08L 77/02; B29L 2031/777; B33Y 70/10; C08K 2201/005; C08K 2201/011; C08L 2207/04

(57) ABSTRACT

A wear resistant component for a firearm comprises a body formed of polymer infused with nanoparticles. The nanoparticles impart high hardness to the otherwise soft polymer which increases abrasion resistance to a level that at least approaches and has similar high wear characteristics as some all metal components but at a fraction of the weight and without the need for metal inserts or overlays on a polymer base. The nanoparticle may be silicon dioxide in preferred embodiments which covalently bonds to the polymer chain becoming an integrated part thereof. Various forms or shapes of nanoparticles may be used. The nanoparticles may be dispersed substantially uniformly throughout the entire component body or may be limited in extent to only the wear region and adjoining wear surface of the component. The nanoparticles may be used for injection molded or 3D printed components or in composite laminated stack structure with reinforcement fibers.

### CROSS-REFERENCE TO RELATED APPLICATIONS

The present application claims the benefit of priority to U.S. Provisional Application No. 63/703,039 filed Oct. 3, 2024, which is incorporated herein by reference in its entirety.

### BACKGROUND

The present invention relates to firearms, and more particularly to firearm components comprising a polymer body formed of a special composite matrix material infused with nanoparticles for high hardness to resist frictional abrasion and high wear.

Fiber reinforced and unreinforced polymeric materials have been utilized for firearm components for more than 50 years. These components include items such as stocks, magazines, handguards, barrels, etc., but have been limited to applications for firearm components that are not exposed to high wear, high friction, and high heat exposure. Polymers in general have much lower hardness properties and poor wear characteristics when exposed to frictional abrasion compared to metals and metal alloys by an order of magnitude. Due to these limitations, use of either fiber reinforced polymer compositions and monolithic polymers without reinforcement for firearm components subjected to high wear and frictional abrasion that require a high hardness material have been extremely limited or non-existent, and without widespread success and acceptance. Accordingly, both fiber reinforced and unreinforced polymers have heretofore been limited in their use to applications in firearms where there is low heat and/or low friction (wear) such as firearm stocks as one example.

In an attempt to remedy this situation if a polymeric material is intended for use in a high wear/abrasion application, the lower hardness polymer materials are co-molded or co-bonded (e.g., adhesives) to a harder metal structure which will be the portion subject to wear and more wear/abrasion resistant than the polymer which alone is unsuitable for such demanding applications. These hybrid firearm components however are more complex and costly to fabricate, and the metal structure adds to the weight of the complete firearm which is particularly undesirable for conceal carry firearms.

A need remains for a polymeric material that can withstand high wear loading in a firearm, while maintaining the lightweight benefits that polymers provide including the ability to mold details into a firearm component that do not require traditional machining associated with metal structures.

### SUMMARY

The present disclosure provides a wear-resistant polymeric composite material suitable for fabricating firearm components having bodies that define one or more wear surfaces subjected to sliding frictional abrasion. The polymeric composite material exhibits high strength and hardness compared to the polymer resin which overcomes the shortcomings of the approaches discussed above to overmold metallic wear surfaces onto polymer material.

The present approach disclosed herein in one non-limiting embodiment adds nano-sized particles (i.e. nanoparticles) to the polymeric resin matrix in a way that dramatically increases the hardness of the polymer while maintaining and/or increasing the strength and other properties of the polymer. The higher hardness imparted to the polymer material is achieved by infusing the polymer with such nanoparticles having a higher hardness than the polymeric base material. This transforms these otherwise softer components to ones suitable for use in high wear applications in the firearm which at least approach or achieve the greater high wear characteristics of all metal components but at a fraction of the weight without the need for metal inserts or overlays on a polymer base. The nanoparticles may be infused and dispersed into a variety of polymeric base resins including for example without limitation epoxy based polymers and thermoplastic based polymers. The polymer resin base material may be unreinforced or fiber reinforced with continuous or discontinuous fibers depending on the nature and type of the firearm component. Common fiber reinforcement used in the art which may be used with the present nanoparticle infused polymer including for example without limitation carbon fibers, glass fibers, aramid fibers (e.g., Kevlar®), basalt fibers, and other suitable fibers.

In one preferred but non-limiting embodiment, the nanoparticle additive infused in the polymer resin matrix is comprised of silicon dioxide (SiO₂). In contrast to other nanoparticles which might be added to the polymer, the silicon dioxide molecule has the unique ability to actually form strong bonds with both plastic and epoxy monomers thereby incorporating the SiO₂ molecules directly into the monomer chain as further described herein rather than being present as merely embedded but unintegrated nanoparticles. This results in a strong integral bond between the polymer and nanoparticles such that the harder nanoparticles are not easily separated from the polymeric base material when exposed to frictional abrasion and wear during operation of the firearm. The nanoparticles therefore remain coupled to the polymer and become gradually worn down or thinned by repeated exposure to wear rather than becoming dislodged from the polymer which would not provide an effective wear resistant surface.

In addition, for polymers which are reinforced with additives such as carbon, glass, or other fibers, the silicon dioxide helps bond/couple the fibers to the polymer chain of molecules resulting in a stronger end product material. The inventors have discovered that these foregoing properties of silicon dioxide contribute to forming a matrix of internally bonded molecules/particles which substantially increases the hardness and wear resistance of firearm components fabricated from polymer infused with this particular nanoparticle.

A nanoparticle is a particle of matter with a size ranging from 1 to 100 nanometers (nm) in size or diameter.

In some non-limiting embodiments, the nanoparticles used in the present polymer matrix comprise silicon dioxide ranging in size from and including 10 nanometers to and including 100 nanometers, and more preferably 10 to 60 nanometers. In one embodiment, the nanoparticles may be about 30 nanometers in size/diameter (+/−5 nanometers representing commercial nanoparticle supplier size tolerance range) which has been found to yield optimum high hardness and wearability.

In various embodiments according to the present disclosure, the nanoparticles may be round or spherical particles in their geometry in some embodiments, or two-dimensional flat platelets (“nano platelets”) with a greater width than thickness in other embodiments. Other shaped nanoparticles may be used. The nanoparticles of either geometry or others in one embodiment are infused and incorporated into the polymeric base material in a random but substantially uniform dispersion or distribution in the wear portion or region of the firearm component defined as the portion or region which is subjected to frictional abrasion during use of the firearm. The wear region in various embodiments depending on the nature of the firearm component may comprise: (i) the entirety of the firearm component in which the nanoparticles are distributed throughout the entirety of the polymeric body of the component; or (ii) a specific or localized region forming only a portion of the entire polymeric body which includes and defines an exposed wear surface of the firearm component which is subjected to the abrasive wear.

In the former arrangement of nanoparticles noted above, a cross-sectional slice taken through the polymeric body of firearm component would reveal a substantially uniform distribution of the nanoparticles in a random pattern throughout the entire interior of the slice (component) from side to side, front to back, and top to bottom. This allows a monolithic piece or mass of the nanoparticle impregnated polymer (either fiber reinforced or unreinforced) to be machined with the necessary appurtenances and features to form the body of the component for use in the firearm. Such a component would have a body with relatively uniform hardness and strength properties throughout the polymeric-nanoparticle matrix so that as the component is worn down after repeated use of the firearm, these material properties remain constant. The wear region in this instance is the entire component.

In the latter arrangement of nanoparticles noted above having a specific or localized dispersion of the nanoparticles in only the anticipated wear region of the polymeric body which is less than the entire firearm component, the nanoparticles may have a random but substantially uniform distribution limited to an either inwardly or outwardly exposed wear surface of the firearm component (depending on the nature of the component) and the adjacent underlying portion below the surface all of which is hardened by the nanoparticle infusion. The nanoparticles are infused in the polymer to a preselected depth or thickness adjoining and below the exposed wear surface to form a wear portion or region with greater strength and wear resistance than the adjacent and remaining portions of only polymer without nanoparticles. These other portions of firearm components do not need the benefit of hardening by nanoparticle infusion. Some examples of firearm components that have limited wear regions and surfaces exposed to repetitive cycles of abrasive wear include but are not limited to ammunition magazine feed lips, pistol slides, or other components or parts of the firearm in which two mating surfaces of the firearm rub or slide against each other during operation of the firearm. Abrasive wear experienced in these type components is thus limited to the interface between the mating parts of the firearm and not the entire component. Infusion of nanoparticles in only the wear region advantageously reduces component fabrication costs.

As the nanoparticle hardened region is exposed to repeated wear and abrasion, the thickness of the wear region will gradually thin over time during repeated use of the firearm yielding a wear life of the firearm component or part. When the hardened wear region either become consumed or experiences a loss of dimension making the firearm components less than fully functional, the part can simply be replaced.

Nanoparticle infusion of the polymeric base material according to the present disclosure can be used with laminated structures for components of firearms. Localized dispersion and concentration of the nanoparticles in a specific portion or region of the firearm component such as only at the wear surface and adjacent region may be used when a laminated component structure is being built with two or more layers of fiber-reinforced material. Layers of fiber and polymer resin material underlying the nanoparticle impregnated wear region of the component do not require nanoparticle infusion to increase wear resistance since these layers are not exposed to abrasive wear. This offers a cost-effective approach for laminated fiber reinforced polymer structures subject to external abrasive wear on specific or the entire outer surfaces of the firearm component.

As the term is used above and herein, a “uniform distribution” of nanoparticles is used consistent with the meaning used in parts manufacturing industry and procedures which means that there are preferably no localized areas of the polymeric base material in the target wear region of the firearm part or component body having one or more dense concentrated clumps or clusters of nanoparticles not present in other portions which would contrarily be characterized as a non-uniform distribution. In other words, the nanoparticles are uniformly distributed in the polymeric material to the extent permitted by the limits of present manufacturing methods throughout the volume of the wear region whether the entire component body or a lesser specific or localized portion of the body only subjected to wear. The uniformity of the spatial distribution of the nanoparticles throughout the intended wear portion of the polymeric base is crucial to the properties of the final component. A non-uniform distribution of nanoparticles would adversely create portions of the expected wear region with lower strength and hardness than other portions of the wear region thereby resulting in softer and weaker spots or areas susceptible to uneven wear which could drastically reduce the performance and life of the firearm component. It is therefore desirable to have a uniform distribution of nanoparticles in the target wear region of the polymeric base material so that at least the firearm component exposed wear surface and adjoining wear portion beneath are imparted with substantially uniform strength and hardness characteristics. Thought of another way, a uniform distribution of nanoparticles means that one portion of the component polymeric body will have substantially the same density or amount of nanoparticles per volume as any other portion.

The term “substantially” used herein in conjunction with a “uniform distribution” of nanoparticles recognizes that present manufacturing techniques for infusing nanoparticles into a polymeric base material will not produce an entirely perfect distribution which is subject to the limits and parameters of the manufacturing technique.

The term “random” used herein in conjunction with a “substantially uniform distribution” of nanoparticles connotes that the nanoparticles need not be arranged with an even pitch spacing between adjacent nanoparticles or arranged in a predetermined geometric or other pattern. The nanoparticles may be spaced apart from each other and/or at least partially overlap in a nested arrangement in the wear region of the polymeric component body in various embodiments of a nanoparticle distribution pattern. The silicon dioxide nanoparticles used in preferred but non-limiting embodiments described herein are themselves extremely hard and far less susceptible to high wear and high frictional loads compared to the polymer alone (fiber reinforced or unreinforced). Once the nanoparticles are dispersed and infused into the polymer, the nanoparticles advantageously act to increase the overall hardness and “wearability” of the polymer base material without having a need for a separate metal structure co-molded or co-bonded together with the polymer to achieve high wear properties as in the past approaches described above. An advantage of the present invention is therefore the elimination of the need to have a separate polymer piece and metal piece combined and bonded together to achieve high wear properties, which reduces the complexity of the fabrication process, cost, and weight of the final firearm component when fabricated according to the present disclosure.

### BRIEF DESCRIPTION OF THE DRAWINGS

The features of the exemplary embodiments will be described with reference to the following drawings where like elements are labeled similarly, and in which:

FIG. 1 is an electron microscope image of nanoparticles in the form of nano platelet particles of silicon dioxide (SiO₂) according to the present disclosure under high magnification;

FIG. 2 is an isometric cross-sectional view of a composite laminate structure infused with nano platelet particles located on the outer wear layer and surface of the composite laminate;

FIG. 3 is an electron microscope image showing nanoparticles in the form of round or spherical nanoparticles of SiO₂ under high magnification;

FIG. 4 is an isometric cross-sectional view of a polymeric structure of a firearm component comprising spherical nanoparticle infused and located throughout the thickness of the composite structure;

FIG. 5 is an isometric view of the nano spherical particles dispersed uniformly throughout and covalently bonded to the polymer chain structure;

FIG. 6 is a chart of surface hardness including testing of various polymeric compositions using the Mohs scale of hardness as measurement;

FIG. 7 is a side view of a modern semi-automatic rifle utilizing a columnar curved magazine to feed ammunition cartridges into the chamber of the barrel of the rifle;

FIG. 8 is an isometric view of the magazine of FIG. 7 showing the polymer magazine body fitted with a metal throat insert that is replaceable with a nanoparticle infused polymer throat insert according to the present disclosure;

FIG. 9 is an isometric view of a rotary style magazine with a metal throat insert that is replaceable with a nanoparticle infused polymer throat insert according to the present disclosure;

FIG. 10 is an isometric view of the throat insert of FIG. 9 in isolation;

FIG. 11 is a side view of a semi-automatic handgun in the form a pistol with a reciprocating slide shown in the ready-to-fire position;

FIG. 12 is a side view of the semi-automatic pistol with the slide shown in the open breech position after firing and movement of the slide;

FIG. 13 is an isometric view of slide of FIGS. 11 and 12 in isolation highlighting the area of high wear;

FIG. 14 is an exploded perspective view of the pistol of FIGS. 11 and 12 showing the slide, pistol grip frame, and fire control frame insert defining high wear components;

FIG. 15 is an isometric view of a Picatinny style rail highlighting the area of high wear;

FIG. 16 is an isometric view of a handguard with ARCA rail highlighting the area of high wear; and

FIG. 17 is an isometric view of a laminated stock for a firearm which may be infused with nanoparticles according to the present disclosure.

All drawings are schematic and not necessarily to scale. Parts given a reference numerical designation in one figure may be considered to be the same parts where they appear in other figures without a numerical designation for brevity unless specifically labeled with a different part number and/or described herein.

### DETAILED DESCRIPTION

The features and benefits of the invention are illustrated and described herein by reference to exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Also, as used in the specification including the appended claims, the singular forms “a,” “an,” and “the” include the plural.

As used throughout, any ranges disclosed herein are used as shorthand for describing each and every value that is within the range. Any value within the range can be selected as the terminus of the range.

In addition, any references which may be cited herein are all hereby incorporated by reference in their entireties. In the event of a conflict in a definition or meaning of a term in the present disclosure and that of a cited reference, the present disclosure controls.

As mentioned earlier, polymeric materials have been utilized extensively within the firearms industry for various firearm components in a wide variety of applications ranging from stocks to actual rifle barrels. In applications in which the component or part is subjected to high heat and/or high wear, polymeric materials alone (either fiber reinforced or unreinforced) have reached a threshold due to the poor wear characteristics and heat limits of polymers. An example of this is what is referred to as a “carbon fiber barrel” that consists of an inner metal barrel wrapped with composite materials around the outside of the metal barrel. The inner metal core is required for both strength and stiffness, but more importantly due to the hardness properties of metal, metals can withstand the extreme wear and heat that is generated by the bullet passing down and slidably contacting the bore of the barrel after firing the firearm.

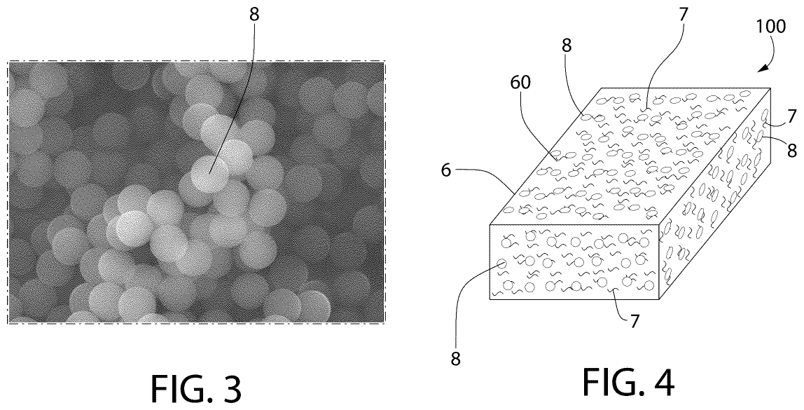

Over the past several years, the field of nanotechnology has grown in both manufacturing capabilities in how nanoparticles are produced, but also in ways in which they are dispersed into polymers to dramatically increase certain properties of the polymeric material. These advancements can be seen in applications like active window tinting, thin film application, circuit board industry, and of course the advanced composite industry. The range of nanomaterials extends from graphene all the way to pure diamond and virtually every mineral. There are different shapes and sizes of nanomaterials (nanoparticles) but typically the term “nano” refers to a particle size in at least one dimension that ranges from one nanometer to one hundred nanometers. Keeping in mind that one nanometer is one billionth of a meter, these particles are so small that the only way to see them is via using a scanning electron microscope (see, e.g., FIGS. 1 and 3).

Within the plastics and composites industries, utilizing fillers in the polymer resin systems to enhance the physical and mechanical and electrical properties of the polymer has historically been achieved using particles that are much larger in size than the current nano versions of the same particle. This typically leads to a reduction in the strength and fatigue properties of the polymer because the larger size of the particle creates a weakness in the substrate.

The present invention solves the negative effects of adding a filler particle in a polymer, by reducing the particle size of the filler to below 100 nanometers and dispersing the nanoparticles in a polymer in a manner that yields a random but substantially uniform dispersion or distribution of the particle within the polymer mass. The nanoparticles are preferably dispersed in the polymer without agglomerating (clumping) so that localized regions of the polymer impregnated with nanoparticles do not have substantially different mechanical properties (e.g., strength and hardness) than other regions.

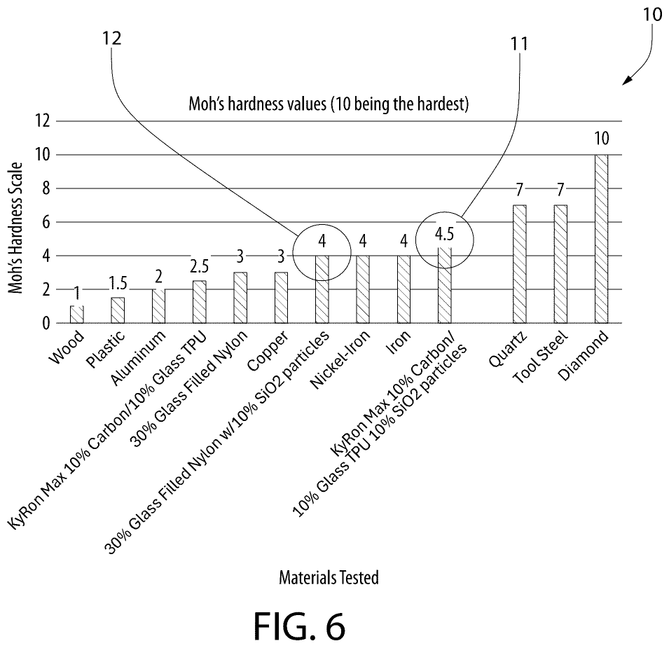

The inventors have discovered that a nanoparticle material found to be optimum for fabrication of firearm components subjected to high abrasion and wear in order to achieve high hardness and low weight/density is preferably silicon dioxide (SiO₂) in one embodiment. In addition to being lightweight, silicon dioxide has a density of 2.2 g/m3 which is one-fourth (¼) the density of tool steel yet has the same hardness as tool steel. This material is commonly referred to as “quartz” which is rated at a Mohs scratch resistant level of 7 out of 10 same as tool steel (see, e.g., Mohs hardness table FIG. 6). Although typical hardness testing for polymers uses a Barcol hardness scale, in the case of the present invention for polymers used to fabricate firearm components or parts, the optimum test method for measuring and characterizing wear resistance is the Mohs scale. This test method, which is well known in the art without further elaboration, measures a material's ability to resist scratching. In the case of firearm applications, products like magazines, pistol slides, and other components undergo significant wear loads where two materials rub tangentially against each other creating friction, heat, and wear.

The silicon dioxide molecule not only has high hardness and is lightweight, but these molecules also exhibit a high covalent bond strength and accept a silane coupling agent allowing great bond strength between both plastic and epoxy monomers. The silicon dioxide nanoparticles therefore covalently bond to the polymer chain which imparts greater strength and hardness to the nanoparticle infused firearm or other component body because in part the nanoparticles cannot become easily separated from the polymer matrix when exposed to abrasive wear. In addition, the nanoparticles create physical bridges between the polymer chains in the polymer. The ability to chemically bond to a wide variety of polymers advantageously distinguishes silicon dioxide nanoparticles from other types of potential nanoparticles that might be used like tungsten carbide, boron nitride, tool steel, etc. These other nanoparticles do not chemically bond to the polymer chain and therefore cannot provide the combination of strength along with the hardness for frictional abrasion resistance (wear) comparable to silicon dioxide. Because of the ability of the silicon dioxide to be chemically integrated and bonded directly into the plastic and epoxy monomer chain, nanoparticles formed of silicon dioxide were found to be ideal for high wear firearm component fabrication.

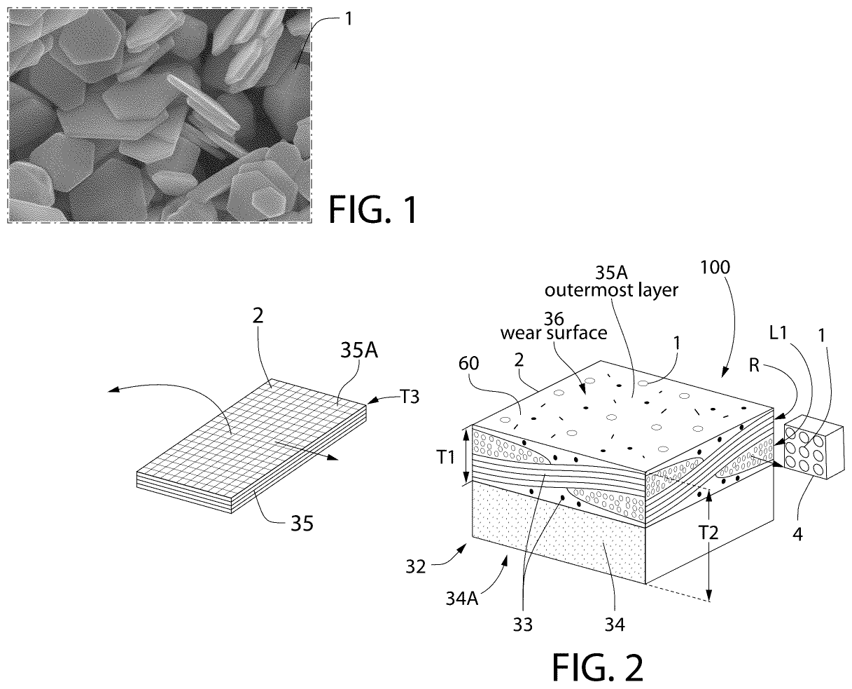

The inventors have determined that the optimum particle size of the silicon dioxide is in the range from about and including 10 nm (nanometers) to and including 100 nm. In one embodiment, a preferred size/dimension of a silicon dioxide nanoparticle is about 30 nm (the term “about” recognizing that +/−5 nanometers is the typical commercial nanoparticle supplier size tolerance range when ordering nanoparticles). Nanoparticles smaller in size if too small (e.g., less than 10 nm) do not yield the necessary hardness for good wear resistance performance. Particles greater than 100 nm degrade the properties of the base polymer itself resulting in decreased strength, etc. and are therefore counterproductive to the achieving a wear resistant firearm component or part. It has also been found that the silicon dioxide nanoparticles can be effective in dramatically increasing the Mohs properties whether they are located and concentrated on and at just the exposed wear surface and the adjoining wear region to a predetermined depth/thickness below the surface (i.e. wear region only of component) utilizing flat platelets or “nano platelets” (see, e.g., FIGS. 1 and 2), or alternatively dispersing the nanoparticles uniformly throughout the entire polymer matrix of the firearm component using a round or spherical form of nanoparticle (see, e.g., FIGS. 3 and 4).

These silicon dioxide nanoparticles and the ability to disperse or distribute these nanoparticles into an injection moldable plastic utilizing a typical conventional injection molding process/apparatus, or traditional hand laid fiber-reinforced thermoset epoxy prepreg advantageously allows for producing very lightweight firearm components that have extremely high-resistance wear properties. This also provides very cost-effective components to be fabricated that require little or no post machining associated with metal parts for the same application which often start as a solid metal block of material requiring extensive machining and shaping.

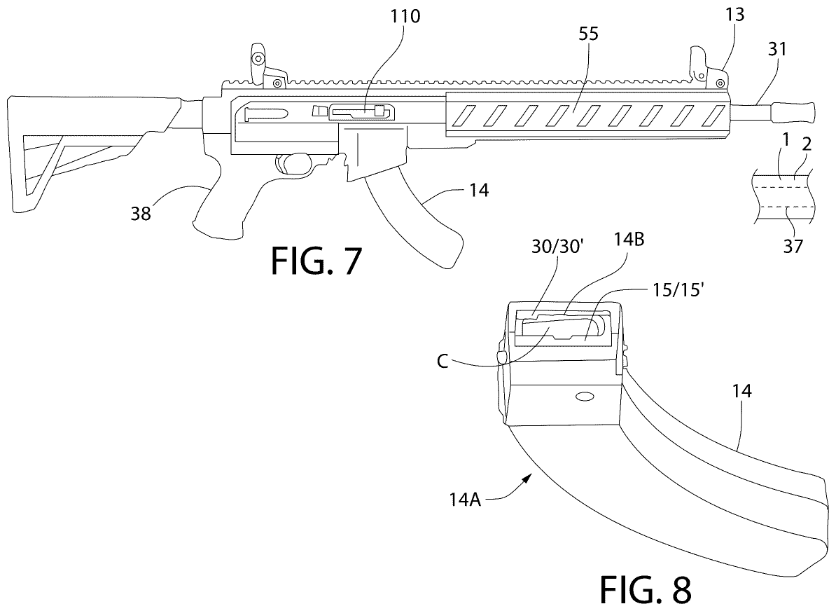

The present silicon dioxide impregnated polymer (fiber reinforced or unreinforced) can be used to fabricate multiple different firearm components which are subjected to frictional abrasion and wear. Examples of these high wear firearm components that can benefit from use of silicon dioxide impregnated polymers are shown in FIGS. 7-16 and further described herein.

The following lists some but not necessarily all of benefits associated with use of silicon dioxide impregnated polymer according to the present disclosure.

### Hardness and Wearability

By adding SiO₂ nanoparticles with superior hardness compared to the polymer by itself, the wearability of the resulting structure increases substantially. Material hardness increases as SiO2 particles reinforce the polymer matrix. SiO₂ dispersion contributes to hardness and wear resistance.

### Weight

SiO2 nanoparticle reinforced polymer components produced according to the present disclosure achieve the equivalent wear resistance compared to tool steel at one-fourth the weight of a comparable steel component.

### Reinforcement and Stiffness

Well-dispersed SiO₂ nanoparticles with a random but substantially uniform distribution act as reinforcement within the polymer matrix. As the SiO₂ content increases, the composite's stiffness (modulus of elasticity) generally improves. SiO₂ particles hinder polymer chain movement, resulting in a stiffer material.

### Strength and Toughness

Proper dispersion of SiO₂ nanoparticles in the polymer matrix enhances the composite's tensile strength and toughness. SiO₂ nanoparticles create physical bridges between polymer chains, improving load transfer and preventing crack propagation. Toughness (resistance to fracture) increases due to better stress distribution.

### Creep Resistance

Creep is the gradual deformation of a material under constant load over time. Well-dispersed SiO₂ reduces creep by restricting polymer chain mobility.

### Fatigue Performance

SiO₂ dispersion in the polymeric base material affects fatigue behavior. Properly dispersed nanoparticles enhance fatigue life by reducing crack initiation and propagation.

### Impact Strength

Impact strength depends on SiO₂ nanoparticle distribution in the polymer. Substantially uniform dispersion or distribution of the SiO2 nanoparticles in the polymeric base material improves impact resistance, as localized stress concentrations are minimized.

### Thermal Properties

SiO₂ nanoparticle dispersion in the polymer influences thermal stability and heat resistance. Nanocomposites exhibit improved thermal stability due to the high smelting point of SiO₂.

### Dimensional Stability

SiO₂ nanoparticle dispersion in a polymeric base material minimizes dimensional changes (e.g., swelling or shrinkage) with temperature variations. This is important in firearm applications due to seasonal variation in ambient temperatures in which the firearm may be used (e.g., hunting in the winter, competition shooting, etc.), and changes in temperature attributed to repeated firing of the firearm since components near the barrel which may get very hot are affected by the increase in heat. In addition, reduced water absorption and thermal expansion occur in well-dispersed nanoparticle composites according to the present disclosure.

As previously described herein, the silicon dioxide nanoparticles infused in the polymeric base material according to the present disclosure can be described as particles that are less than 100 nanometers in size. The shape of the particles as previously denoted can vary however as portrayed in FIGS. 1 and 3 depending on the intended application, the nature of the particular firearm component and exposure to wear, and other factors, as further described herein.

The present disclosure provides two ways or methods in which high hardness levels in polymeric materials can be achieved via the incorporation of nanoparticles according to the present disclosure. The first method in some embodiments is the use of nanoparticles in the form of nano platelets (FIGS. 1 and 2) distributed and concentrated in a localized manner primarily in the exposed wear regions and associated exposed wear surface of the firearm component. The second method in other embodiments is the use of round or spherical nanoparticles (FIGS. 3 and 4) that are dispersed throughout the entire resin matrix structure. Each method is further described below.

The nanoparticle shape shown in FIG. 1 is the flat platelet form previously described and referred to herein as a “nano platelet” 1. Nano platelets are flat nanoscale particles each having have a substantially greater width than thickness with high surface area and aspect ratios in contrast to round/spherical nanoparticles. The nano platelets may have any profile or shape forming the perimeter and peripheral edges thereof including polygonal, non-polygonal, combinations thereof, or irregular shapes. In preferred embodiments, the nano platelets have a width ranging from about and including 200 to 500 nanometers (less than 1 micrometer) which can provide optimum performance for forming a wear layer. In some embodiments a combination of these sizes are used together to infuse the polymer so the smaller platelets migrate into and fills voids between the larger platelets when infused into the polymeric body. The nano platelet is the optimum shape for use in a firearm component or part via the above first method when only the exposed wear surface of the component structure and adjoining wear region immediately below the surface will benefit from an infusion of the nanoparticles to increase mechanical strength and wear resistance to frictional abrasion by forming a hardened skeletonized shell or coating on the component. Accordingly, for such firearm components, only a localized wear portion or region of the polymer component having a volume less than the total volume of the components needs to be reinforced with the nano platelet infusion. In some embodiments, only a single layer of nano platelets 1 may be infused into and onto the exposed surface of the polymeric component to form a hardened wear surface.

The shape and nature of nano platelets 1 provides for a very thin flat layering of the particles and ensures 100% coverage on the outer wear surface of the composite polymeric structure exposed to the mating firearm component or part which slidably engages and abrades the exposed surface of the composite over time. Accordingly, one or more layers of nano platelets may be infused and dispersed in and over the wear surface and adjoining region thereunder of the firearm component in an arrangement so that a majority of the platelets at least partially overlap, and more preferably substantially overlap with each other in a nested arrangement thereby advantageously forming a continuous wear-resistant surface and barrier. The nano platelets are arranged and organized in a random non-unform orientation with respect to each other as shown in FIG. 1 so that a single thin layer having a thickness formed by a plurality of the nanoparticles when measured normal to the exterior surface of the polymeric firearm component being built. The single thin wear layer as described herein does not mean that there is no vertical stacking of nano platelets within the thin layer due to their overlapping arrangement which naturally will occur due to the random orientation and distribution of nano platelets within the layer. Theoretically with such an arrangement of overlapping nano platelets formed into a thin wear layer there are no open gaps/voids between at least a majority of the nano platelets, and preferably no open gaps/voids between any of the platelets in the thin wear layer in which the polymer without nanoparticles beneath the nano platelet wear layer is outwardly exposed to wear. This latter nano platelet structure without gaps/voids can be attained by providing a sufficient loading or quantity of 10% by volume of nano platelets in the targeted wear region with exposed wear surface of the polymeric component body. The nested overlapping arrangement of nano platelets in one embodiment thus provides a thin hardened skeletonized exposed wear layer and surface that can conform to tight areas with a small radii in the component or part geometry to maintain a uniform hardened wear surface over the entire the component or part. This is why the preferred platelet particle size range less than 1 micrometer (e.g., 200 to 500 nanometers in width) is larger than the round nanoparticles used in other embodiments in which the nanoparticles are instead infused and suspended throughout the interior of the injection molded polymer body as described elsewhere herein. In some embodiments, there is no backing structure or tape on which the nano platelets are supported or affixed to as the nano platelets are to be mixed with the polymer resin to form the exposed hardened wear layer.

A fiber-reinforced composite laminated structure 32 forming at least a portion of the complete firearm component body 100 with nanoparticle infusion is shown in FIG. 2. The structure 32 may utilize the flat platelet form of silicon dioxide nanoparticles (nano platelets 1) to maximum advantage, or alternatively may use the spherical form of nanoparticles shown in FIG. 3 in some embodiments. The laminated structure 32 comprises a laminate stack 2 formed of multiple layers 35 of prepreg (pre-impregnated) each including reinforcing fibers 33 embedded in a partially cured polymer matrix 60. The fiber reinforced polymer resin layers are wrapped over or built upon the preceding underlying prepreg layer to collectively form a laminate stack 2 of layers 35 when cured and bonded together to harden the structure via heating. In some embodiments of firearm components, the laminate stack may in turn be built and formed upon an underlying solid base material 34A which may be a metal base 34 to which the laminate is bonded during curing and heating. One non-limiting example of such a firearm component is a composite firearm barrel 31 with cylindrical inner steel barrel 37 wrapped with an outer laminate stack 2 of layers 35 at least a portion of which is impregnated with nano platelets 1 (see, e.g., FIG. 7 showing an extracted portion of the barrel in cross section). In some embodiments, only the outermost layer 35A and exposed wear surface 36 thereof of the laminate stack on barrel 37 may be impregnated with nano platelets (see also FIG. 2).

The nano platelet impregnated laminate stack may alternatively be formed and used with other underlying metal bases 34 of different and varying shapes for other types of firearm components or parts, or in some embodiments parts unrelated to firearms. The base material 34A of the laminated structure 32 on which the laminate stack 2 may be formed in still other embodiments may be non-metallic (e.g., plastic, graphite, etc.).

With reference to FIG. 2, the wear region R defines the targeted portion and location on the firearm component body 100 which experiences abrasion and wear to be infused with nanoparticles. The location, shape, depth, and extent of the wear region R will vary from one type of firearm component to another depending on its application in the firearm. For example, in the laminate structure embodiment in FIG. 2, the nano platelets 1 may be confined to the wear region R which is in this case is defined by only outermost layer 35A of the laminate stack 2 that defines the exposed wear surface 36. In this example, the nano platelet infused outermost layer 35A may be considered as the wear layer L1 which undergoes abrasion during use of the firearm component. The wear layer L1 thus extends for a depth and defines a thickness T3. Thickness T3 may be less than the thickness T1 of the entire laminate stack 2 (i.e. all layers) and less than the total thickness T2 of the entire component body 100 which includes the laminate stack and the metallic or non-metallic base material 34A. The base material 34A does not contain nano platelets or nanoparticles of any form. The layers 35 of the laminate stack 2 underlying the wear layer L1 (e.g., outermost layer 35A) also may not contain nano platelets in some embodiments, or in other embodiments may contain nano platelets.

Alternatively, to ensure that some nanoparticle hardened polymeric material remains after the exposed outermost layer 35A (wear layer L1) shown in FIG. 2 is partially eroded away by abrasive forces, the nano platelets 1 may be distributed farther inwards into the component from the outermost layer into one or more inner layers 35 beneath and adjoining the single outwardly exposed wear layer. This defines a deeper/thicker wear layer L1 greater in thickness than just the outermost layer 35A.

In yet other embodiments, however, the entire laminate stack 2 (i.e. all layers 35) may be infused with nano platelets. In some possible embodiments, the outermost layer 35A of the laminate stack 2 may be infused with nano platelets whereas the adjoining layers of the stack beneath the outermost layer may be infused with nanoparticles of the spherical/round form to add hardness and strength to the underlying layering supporting the outermost layer. In other less preferred but satisfactory embodiments, the outermost layer may be infused with spherical/round nanoparticles in lieu of nano platelets if possibly only moderate wear is expected in use. Accordingly, numerous combinations of nanoparticle shapes and polymeric firearm component structures infused with nanoparticles are possible.

With continuing reference to FIG. 2 as the present non-limiting example, after the nano platelets 1 are infused into the resin and fiber matrix, the still partially cured laminate stack is then fully cured along with an underlying metal base 34 in illustrated embodiment under heat and pressure creating the completed composite laminate structure 32 forming the component body 100 which comprises the laminate stack 2 and metal base 34. The nanoparticles (nano platelets 1 in this embodiment) will become bound to and permanently integrated into the wear layer L1 and wear surface 36 as an integral part thereof during the process of curing the laminate.

Any suitable type of reinforcing fibers 33 commonly used in the art to reinforce polymer resin and form the foregoing nanoparticle impregnated and hardened laminated structures 32 including without limitation carbon fibers, glass fibers, etc. as some examples. Any suitable form of reinforcing fibers may also be used including individual strands of fibers, chopped fibers, woven fiber cloth (e.g., fiberglass cloth), etc. as some examples. Continuous reinforcing fibers may be used in some embodiments (see, e.g., FIG. 2). As readily understood by those skilled in the art, such continuous reinforcing fibers are long strands of fiber having long lengths which may extend completely through each layer of the laminate stack 2 from edge to edge for flat laminate stacks, or circumferentially completely around the laminate stack for those having circular cross-sectional shapes. The continuous reinforcing fibers may be arranged in any suitable pattern in each resin layer of the stack 2. One such pattern often used may be in the form of a weave in which fibers in a layer of the laminate stack are oriented along a single angular direction and parallel to each other. Fibers in adjacent layers may be oriented in different angular directions to form a crisscross weave pattern when a transverse cross-section is taken throughout the laminate stack 2. Such a reinforcing fiber weave pattern is well known in the art without further elaboration necessary. The weave pattern provides strength in different multiple directions and planes to structurally reinforce the polymer resin matrix.

In situations where a highly reinforced laminate with continuous reinforcing fibers 33 is required due to high flexural loading conditions such as for example without limitation a firearm barrels having an inner steel core as the metal base 32 and outer fiber-polymer resin reinforces layers (i.e. laminate stack 2), the processing of laminates like this require placing the nano platelets 1 on one or more of the outer exposed wear surfaces 3 where high wear loads will be encountered. The nano platelets 1 are an ideal form for this type of composite structure because they can be placed in the outermost fiber reinforced resin layer 35 on its outer surface prior to curing and will nest on and in the surface (which is typically resin rich) to create an outermost wear layer L1 of the laminate stack 2 which has very high hardness that is far less susceptible to abrasive wear. Reference numeral 4 in FIG. 2 represents a section of the wear layer L1 extracted from laminate stack 2 including and schematically showing the nano platelets 1 represented by circles for ease and clarity of illustration (recognizing that the nano platelets each have a flat configuration and may be arranged to preferably at least partially overlap in a random pattern instead as shown in FIG. 1).

Preferably, the nano platelets 1 are densely packed into and onto at least the outermost exposed wear surface 36 in the outermost layer 35A so that the platelets at least partially overlap to form a contiguous wear-resistant barrier to frictional abrasion. In some embodiments the outermost layer 35A of the laminate stack 2 and one or more adjoining layers 35 immediately below may contain nano platelets 1 forming multiple nano platelet infused layers thereby creating a thicker wear layer L1 having a thickness T3 of the platelets (i.e. not a single layer). After the laminate stack 2 is cured as described above, the nanoparticles (nano platelets 1 in this embodiment) will become bound to and permanently integrated into the wear surface as an integral part thereof.

Although FIG. 2 and the foregoing discussion describe the application and bonding of the laminate stack 2 to a metal base, in other embodiments the laminate stack of fiber-reinforced nanoparticle infused resin may be used to form a self-supporting composite component body 100 for a firearm (or other type non-firearm apparatus) on its own without underlying support from a metal base or structure. One non-limiting example in the firearm arts is a handguard 55 for a long gun such as an AR rifle as shown or another (see, e.g., FIG. 7). Accordingly, the use of nano platelets 1 to form a fiber reinforced composite structure does not require combination with an underlying metal base or structure in all embodiments for support and is expressly not limited to such.

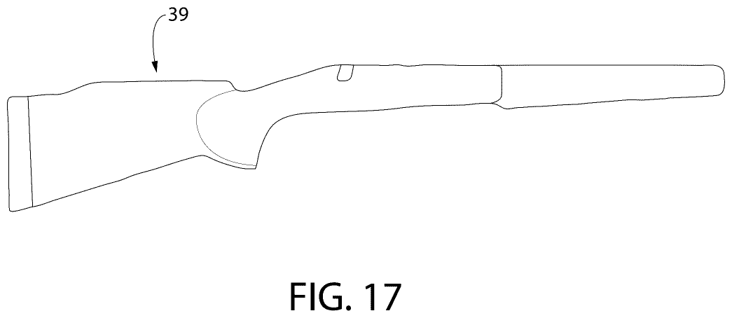

FIGS. 7 and 17 show laminated fiber-reinforced firearm stocks 38, 39 which are another example of a firearm component body 100 that can be impregnated with nanoparticles that does not require an underlying metal base 34 for support in some embodiments. Laminated fiberglass stocks as one non-limiting example are an alternative to wood stocks due to their high structural strength and are largely unaffected by moisture and temperature variations. Unlike wood laminates which are made of layered wood and resin, fiberglass stocks use layers of fiberglass cloth bonded with epoxy resin to create a strong, rigid, and lightweight material suitable for precision shooting in various conditions. Similarly to handguards described above, firearm stocks are not only exposed to abrasion and wear from outside forces during use of the firearm but also are subjected to impact loads from objects which might come into contact with the stock. To impart increased surface hardness to resist wear/abrasion and structural strength, at least the outermost wear region R of the component body 100 of the laminate stack 2 formed in a similar manner to that described above for laminate structure 32 may similarly be impregnated with nanoparticles such as nano platelets 1 applied in a concentrated or localized manner to the outer exposed wear surface 36 of the stock and optionally the adjoining region immediately below the wear surface. In some embodiments, innermost regions of the laminate stack 2 of the stock 38 not exposed to wear may be devoid of nano platelets 1 and only the outermost region of the stock 38 (i.e. wear layer L1) may comprise nano platelets. In other possible embodiments, the entire thickness of the stock may be infused with nanoparticles of either platelet or spherical variety if it is desired to increase the overall strength and hardness of the entire stock uniformly.

Although the laminated structure discussed above has been described in conjunction with use of nanoparticles of the nano platelet form, spherical or other shapes of nanoparticles may be used with the laminate stack.

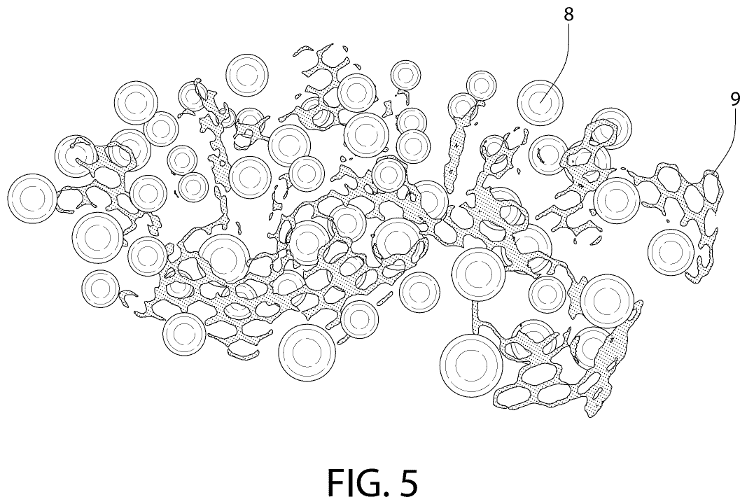

FIG. 5 graphically illustrates and provides a better understanding of the unique properties of round or spherical nanoparticles 8 formed of silicon dioxide when mixed in the polymer matrix. The nanoparticles 8 are shown interspersed and covalently bonded directly to the polymer chain 9 as previously described herein. As discussed elsewhere herein, this unique attribute of silicon dioxide nanoparticles creates greater hardness and wear resistance which alone distinguishes silicon dioxide nanoparticles from other type nanoparticles that might be used which are incapable of becoming an integral part of the polymer chain and therefore cannot provide a comparable combination of strength along with the hardness for frictional abrasion resistance (wear) as silicon dioxide.

FIGS. 3 and 4 show one representative embodiment of a composite nanoparticle-polymer composite structure 6 formed with round/spherical nanoparticles 8 in a polymer matrix 60. Composite structure 6 forms at least part or the complete component body 100. A simple rectangular-shaped structure is shown for simplicity of illustration recognizing that each different firearm component formed by such composite structure can have a multitude of shapes and configurations. The spherical nanoparticles 8 are infused into and throughout the polymer base material which may be a injection molded or cast in a conventional manner using injection molds thereby forming a monolithic piece or body 100 of nanoparticle infused polymer (i.e. the component) whether it be an epoxy matrix or thermoplastic matrix as some examples. The nanoparticle molecules are arranged in a random but substantially uniform distribution previously described herein throughout the thickness of the polymer material. Accordingly, the nanoparticles 8 are preferably blended and uniformly mixed throughout the polymer resin and resulting composite structure so that the nanoparticles do not agglomerate into clusters of densified nanoparticles but instead are evenly distributed throughout the composite structure in a random but substantially uniform fashion or distribution. This approach is ideal for an injection molded thermoplastic fiber reinforced polymer that typically has very complex shapes which require molding rather than and in contrast to the laminated layered composite structure referenced earlier in FIG. 2.

The round or spherical form of nanoparticles 8 and injection molding can be used with or without reinforcing fibers in the polymeric base material. When used, the reinforcing fibers 7 are preferably evenly blended into and distributed throughout the polymer matrix similarly to the nanoparticles 8. The process of using round nanoparticles 8 throughout the thickness of the structure 6 (e.g., component body 100) advantageously allows for machining the part after curing to remove material in order to create various features required. So regardless of where the wear surface is in the firearm component structure after machining or when undergoing abrasive wear during use, the nanoparticles will nonetheless remain on and at the exposes wear surface of the article and not disappear after the part has been machined.

The reinforcing fibers 7 used to form the foregoing composite polymer impregnated with round/spherical nanoparticles 8 may be discontinuous reinforcing fibers. Discontinuous reinforcing fibers are typically formed of chopped fibers having short lengths (e.g., carbon fibers, glass fibers, etc.) when compared to the long continuous fibers used for laminate structures discussed above. The addition of discontinuous reinforcing fibers increase the mechanical strength of the polymer-nanoparticle composite in contrast to unreinforced polymer-nanoparticle resins formed according to the present disclosure. The reinforcing fibers 7 which are dispersed throughout the nanoparticle impregnated polymer structure 6 and intermingled with the nanoparticles 8 in a random pattern but distributed substantially uniformly throughout (see, e.g., FIG. 4). Advantageously, both the discontinuous reinforcing fibers and nanoparticles 8 may be used in firearm components or other non-firearm component fabrication processes such as injection molding, compression molding, and/or extrusion.

The firearm or other type component body 100 infused throughout with spherical nanoparticles will exhibit a substantially uniform hardness in all parts of the body volume. In embodiments using nanoparticles which are limited to only a wear region forming a portion of the entire component body, the wear region will exhibit a substantially uniform hardness throughout the body. The term “substantially” here is used to mean an effective range of variation to be +/−a hardness of 1 on the Mohs scale for surface hardness.

In other embodiments, the nanoparticle-polymer material may be unreinforced without fibers for certain applications.

The nanoparticle polymer infusion technology disclosed herein using silicon dioxide particles can also be used with 3D printing for forming polymeric firearm or other components in addition to the injection molding or lamination processes described above. The 3D printing polymer wire formed material could be made with the nanoparticles contained with the polymer filament. During the 3D printing process, the particles will remain suspended within the polymer and will exhibit the same performance as an injection molded polymer with the same particles.

### Polymer Compositions and Test Results

FIG. 6 is a chart of the Mohs scale of hardness 10 showing actual test data plotted from different composite polymers that contain nanoparticles of silicon dioxide (SiO₂) in addition to composite polymers with the same composition but without the SiO₂ nanoparticles added. Polymer 12 was comprised of 30% glass-filled nylon with 10% SiO₂ nanoparticles. Polymer 11 was comprised of 10% Kyron MAX® (commercially-available from Mitsubishi Chemical Group), 10% carbon fiber, 10% glass fiber TPU (thermoplastic polyurethane), and 10% SiO₂ nanoparticles. All percentages refer to volumetric percentages. The hardness test data chart of FIG. 6 was generated from tests conducted using the round/spherical form of nanoparticles (30 nm size). The hardness values for nano platelets can be expected to be at least the same (e.g., 4 Mohs or more as described below) but possibly greater since the nano platelets are preferably arranged in a tight overlapping nested relationship concentrated in the exposed wear surface region in contrast to spherical nanoparticles which are distributed throughout the entirety of the polymer body (including all interior regions) with some degree of open spacing between some of the nanoparticles. Preferably, the nano platelets are arranged in at least partially overlapping relationship such that there are no open voids or gaps formed through the nano platelet wear layer to the polymer-only base material below between at least a majority of the nano platelets when applied to the wear region (e.g., exposed wear surface of the component), and more preferably no open gaps exist between the overlapping nano platelets in the entire hardened skeletonized wear layer defining the exposed wear surface which might adversely affect the wear resistance properties of the skeletonized layer by leaving voids of exposed polymer base material between nano platelets that would be susceptible to accelerated wear. The lack of voids or open gaps between the nano platelets contributes to the formation of an effective outer hardened skeletonized wear structure or barrier.

In addition to the polymers tested on this chart, the chart includes reference minerals and where they land on the Mohs scale 10. Unlike typical hardness test methods like a Rockwell Hardness test or Barcol Hardness test, the Mohs scale is test for surface hardness and relates directly to a material's ability to resist wear. The Mohs scale is commonly used to assess minerals and is a relative test with a scale of 1 to 10. A value or rating of 1 being a very soft material with little or no wear characteristics like wood, up to a very hard material like diamond with a value or rating of 10.

From experimentation, one can see in FIG. 6 the original hardness of the polymers in columns 4 and 5 from the left (Kyron MAX® 10% Carbon/10% Glass TPU and 30% Glass Filled Nylon) having a Mohs rating of 2.5 and 3 respectively without the infusion of SiO₂ nanoparticles used in the compositions for polymers 11 and 12. This hardness level is similar in range to aluminum and copper which are considered poor from a wearability standpoint (i.e. wear resistance). After these same polymers were infused with the SiO₂ nanoparticles according to the present disclosure, the Mohs hardness ratings advantageously increased to 4 and 4.5 respectively for polymers 11 and 12. The increase is dramatic and places these materials on the same scale as iron and nickel iron which are considered to be excellent materials from a wear standpoint. The inventors were able to achieve these results with just a modest density increase of the polymer which increased from 1.2 g/cm3 to 1.35 g/cm3, thereby maintaining a relatively light weight advantageous for firearms particularly concealed carry firearms. Since SiO₂ nanoparticles are considered to be quartz which has a Mohs rating of 7, the blending of these very hard particles combined with a polymer yield a combined rating of 4 and 4.5 respectively for polymers 12 and 11 as shown. This was at a loading of 10% SiO₂ nanoparticles to the polymer based upon volume for polymers 12 and 11. Higher particle loadings were tested but resulted in negative impacts to the polymer properties and presented challenges in uniform dispersion throughout the polymer. Therefore, it was found that a 10% by volume loading was the optimum loading percentage which also balances hardness imputed to the polymer base material and cost which increases with the addition of further percentages of the nanoparticles which are relatively expensive, thereby increasing the cost of the final nanoparticle-polymer component.

The figures and description provided above detail the nanoparticles and the two different methods of application including the resulting increases in hardness values based upon the Mohs scale (which correlates directly to wear resistance) that can be achieved with the infusion of SiO₂ nanoparticles. This new nanoparticle reinforced polymeric matrix material can be used in a variety of firearm component applications in areas where the components are subject to high abrasive wear and friction during repetitive use of the firearm. The nanoparticle infused polymer component (spherical or nano platelets) may be used and coupled directly to the firearm. Or alternatively, the nanoparticle infused polymer components may be a sub-component coupled to another polymer or metallic firearm component which in turn is used and coupled to the firearm. Following are some examples of nanoparticle infused firearm components and sub-components.

FIG. 7 represents a typical AR-style semi-automatic rifle 13 with a curved box style ammunition clip or magazine 14 that holds numerous rounds of ammunition and can be fired at a high cyclic rate. Such magazines include for example the Ruger BX-25 (25 round) which is commercially-available. There are numerous components and portions of components on these types of rifles that undergo high wear and high friction due to heat which can be replaced with nanoparticle infused polymer according to the present disclosure. Some of these components include the action (e.g., bolt 110 with the firing pin), the extractor on the bolt (not shown) which extracts spent cartridge casings from the chamber after firing, and the upper magazine throat area feed lips 15 at the top opening of the magazine 14.

FIG. 8 is an enlarged perspective view of the magazine 14 from FIG. 7 in isolation. The magazine comprises a plastic (polymer) body 14A and a metal throat insert 30 mechanically coupled to the top opening of the magazine. A spring-loaded stack of ammunition cartridges are automatically dispensed from the magazine each time the action of the firearm is cycled and fed into the rear chamber of the firearm barrel in a firing position. Sliding engagement between the cartridges and feed lips 15 as the cartridges C are dispensed by the spring-biased magazine follower 14B inside the magazine body or tube creates significant wear on the feed lips which is why this particular part heretofore has been made of metal.

According to the present disclosure, the prior metal feed lips 15 can advantageously be replaced with much lighter polymer feed lips 15′ formed of polymer infused with SiO₂ nanoparticles that is able to withstand these types of high abrasive wear loads while offering the advantage of weight reduction. The metal throat insert 30 may be replaced with a polymeric throat insert 30′ formed of nanoparticle infused polymer according to the present disclosure. The polymeric throat insert may be mechanically coupled to the top opening of the magazine in the same manner as the prior metal throat insert. In this hybrid polymer construction, the body 14A of the magazine 14 without the nanoparticles may be formed of a polymer composition having a lower strength and hardness than the polymeric throat insert 30′ which contains the nanoparticles. In some embodiments, the magazine may not require a throat insert such as in some pistol or lower capacity rifle/carbine magazines. In such constructions, the entire magazine body may be fabricated of polymer and only the integral monolithic top portion of the magazine body which defines the feed lips may be infused with nanoparticles to increase hardness and wear resistance.

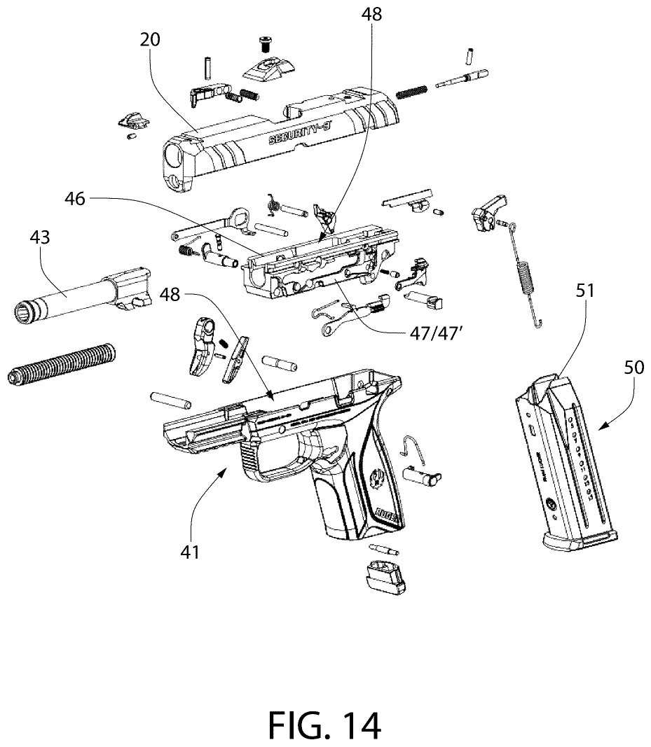

Although FIGS. 7 and 8 depict a curved box-style magazine, it will be appreciated by those skilled in the art that commonly used straight box style magazines 50 used for pistols or rifles/carbines having a straight in lieu of curved magazine tube as shown in FIG. 14 can be used with feed lips 51 impregnated with nanoparticle infused polymer according to the present disclosure as described above. The entire magazine body may be fabricated of polymer and only the integral monolithic top portion of the magazine body which defines the feed lips may be infused with nanoparticles in some embodiments. Or the polymer infused magazine lips may be a separate component coupled to the upper portion of the polymeric magazine body.

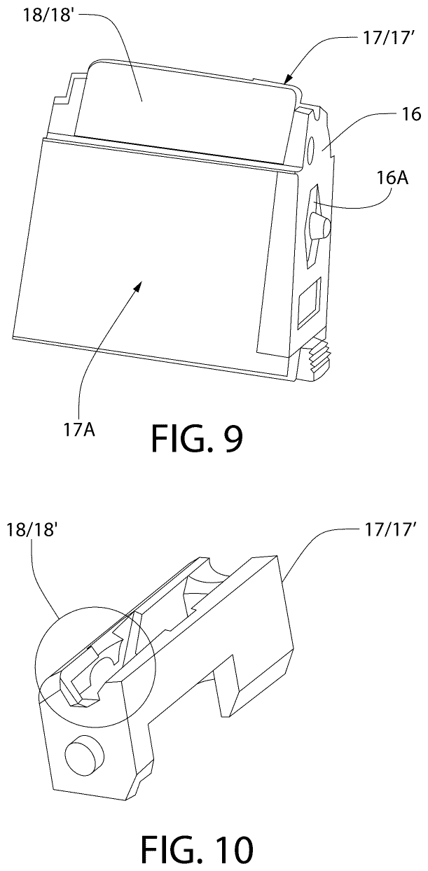

Another example of a high wear firearm component in the form of a different type of ammunition magazine is portrayed in FIGS. 9 and 10 which may benefit from and is usable with nanoparticle infused polymer according to the present disclosure. FIG. 9 depicts what is termed a “rotary magazine” 16 in the art that again feeds bullets into the firearm but uses a rotary spring-biased paddle or rotor 16A to dispense ammunition cartridges into the breech area of the firearm. Such magazines include the Ruger BX-1 ten round magazine which is commercially-available. The magazine shown includes a polymer body 17A fitted with a metal throat insert 17 mechanically coupled to the body that defines the integral feed lips 18 to better resist abrasion as cartridges are dispensed. The feed lips of this type magazine 16 undergoes the same wear loads and frictional abrasion as the curved magazine referenced in FIG. 7 does, except that the magazine housing and cartridge feed spring mechanisms are different.

FIG. 10 shows the metal throat insert 18 removed from magazine 16 shown in FIG. 9 and in isolation. The metal throat insert 18 may be replaced with a polymeric throat insert 17′ comprising nanoparticle infused polymer according to the present disclosure to reduce weight but provide enhanced wear resistance properties. The polymeric insert may be mechanically coupled to the top opening of the magazine in the same manner as the prior metal throat insert (e.g., suitable mechanical coupling). In this hybrid polymer construction, the body 17A of the magazine 16 without the nanoparticles may be formed of a polymer composition not infused with nanoparticles having a lower strength and hardness than the polymeric throat insert 17′ which defines the integral feed lips 18′ which contains the nanoparticles.

Accordingly in the foregoing magazine examples, it is clear that the body 100 of the component which is infused with nanoparticles to increase strength and hardness is configured for coupling to another firearm component by suitable means known in the art which may be formed of a polymeric or other non-polymeric material which does not contain nanoparticles. In some embodiments contemplated, the nanoparticle infused polymeric component could be coupled to a metallic firearm component. Numerous combinations of metallic and non-metallic component parts may be used with a high hardness nanoparticle infused component coupled thereto which is formed according to the present disclosure.

In every type of firearm, there exists various components and portions thereof that undergo repeated abrasive wear and friction. These firearm platforms include rifles, pistols, shotguns, revolvers, etc. and all have components that have varying degrees of wear on subcomponents.

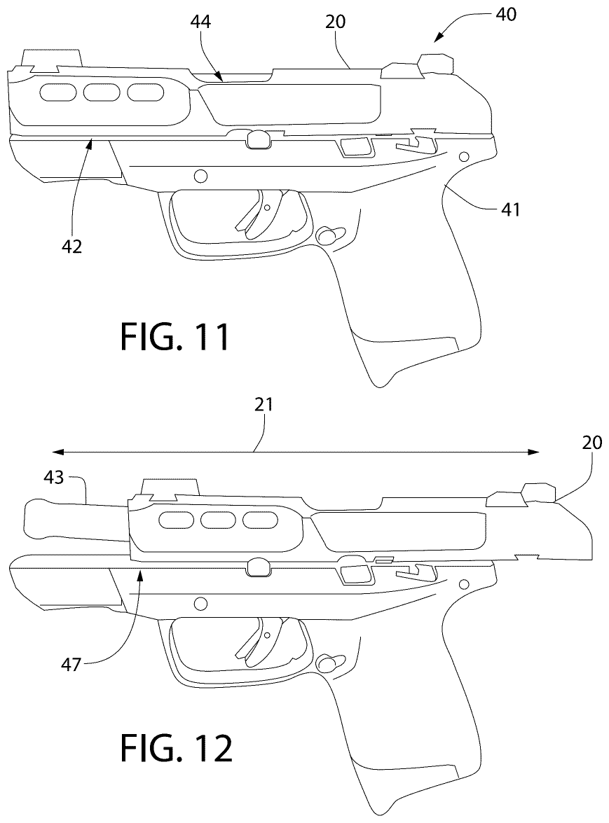

FIGS. 11 and 12 show a typical semi-automatic handgun 40 (e.g., pistol in this case) in a loaded ready to fire condition and the fired condition, respectively. The pistol slide 20 reciprocates linearly back and forth as shown by bidirectional arrow 21 between ammunition rounds fired and is the number one area of high wear loads in this platform category of firearm. Slide 20 defines the breech face located in the breech area 44 of the handgun to form a closed breech when in battery with the rear breech end of the barrel 43 that defines the chamber for the ammunition cartridge (FIG. 11). The slide is slidably supported on the top of the grip frame 41 to form the closed breech when forward and open breech when slid rearward after firing or manually cycling the action which is shown in FIG. 12. The wear surfaces are formed at the sliding interface 42 between the bottom portions of the slide 20 and top portions on the grip frame 41. A mating longitudinal rail combination is often used to form the sliding interface which is well known in the art for slide-operated semiautomatic pistols; however, other configurations of sliding interfaces may of course be used and encountered. In the conventional construction, the slide 20 is typically an all-metal firearm component for wear resistance, or alternatively a combination of a polymer that is over molded onto a metal wear piece that is located in the high wear areas 23 of the slide on the bottom thereof itself at the slide-to-grip frame interface 42. A conventional polymer that lacks the appropriate hardness and wear characteristics will quickly fail in this type of application if not reinforced with a metal wear piece.

Advantageously, a polymer infused throughout with round/spherical SiO2 nanoparticles 8 according to the present disclosure will survive the harsh wear loads created by firing the handgun thereby providing a suitable wear life. Typically, these metal slides are the single highest cost component in a modern semi-automatic handgun due to the amount of extensive and time-consuming metal machining that must take place. With this preferred embodiment according to the present disclosure, the slide can advantageously be injection molded from a fiber reinforced polymeric matrix that contains spherical SiO₂ nanoparticles to increase strength and hardness to be able to withstand this harsh wear environment and repeated cycles of operation. This ability to injection mold these types of parts from nanoparticle infused polymer results in a much lower cost and lighter weight slide even compared to all metal or even polymer slides over molded onto a metal wear piece as provided in the past.

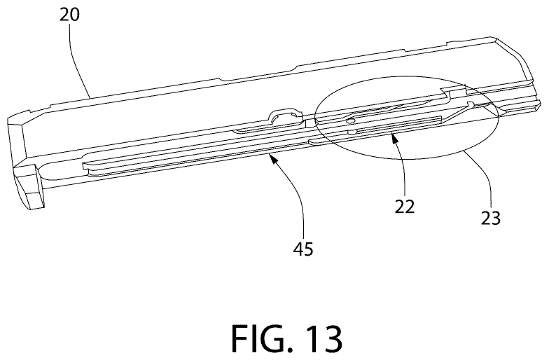

FIG. 13 shows slide 20 in detail and isolation removed from the pistol grip frame 41. The underside of the slide 20 represents the wear area 23 that defines the longitudinal wear surfaces 22 of the slide that has the highest wear associated with the slide. A wear surface is typically formed on the bottom edge of each side of the slide as shown. As one can see, this wear area 23 of the slide comprises a pair of laterally spaced longitudinal rails 45 which slidably engage mating longitudinal rails 46 formed on the top of a metal fire control frame insert 47 inserted into the upwardly open cavity 48 the grip frame 41 of the pistol as shown in FIG. 14. Rails 45 and 46 collectively define the sliding interface 42 therebetween. Such an assembly marrying a metal frame insert paired with a plastic grip frame is well known in the art so that rails 46 can be formed of metal for wear resistance while concomitantly reducing the weight of the grip frame. Rails 46 of the frame insert 47 define the metal wear surfaces 48 which mate with the wear surfaces 22 defined by rails 45 of the slide 20.

It bears noting that the rail geometry of the slide has very thin walls that contact the mating metal sub frame formed by the rails of the grip frame 41 of the pistol. Therefore, a sufficiently hardened and wear resistant rails are needed for the slide. When the firearm is fired, the slide 20 reciprocates rapidly back and forth on the grip frame/frame insert at very high speeds and high cyclic rates which creates extreme friction and wear on the two wear surfaces in contact on rails 45, 46. Heretofore, this demanded a metal to metal interface.

The present disclosure advantageously provides the ability to now injection mold a slide formed of reinforced polymer (e.g., discontinuous reinforcing fibers) with enhanced hardness and wear resistance attributed to an infusion of silicon dioxide round/spherical nanoparticles 8 throughout the entire monolithic body of the slide 20 according to the present disclosure. By obviating the need for any metal components in the slide, a significantly lighter weight slide may be provided which will recover quicker than a metal slide due to its reduced weight, thereby improving the action of the firearm.

In some embodiments, the fire control frame insert 47 heretofore made of all metal may also now similarly be formed with reinforced polymer infused with silicon dioxide round/spherical nanoparticles 8 for enhanced hardness and wear resistance. This offers further weight reduction possibilities which is especially advantageous for concealed-carry firearms for obvious reasons including ease of handling, aiming, and carrying. The nanoparticle infused frame insert 47′ may be mechanically coupled to the conventional polymeric grip frame 41 without nanoparticles as shown in FIG. 14 by any suitable means known in the art. Although the polymer grip frame does not contain nanoparticles, such polymer frames are often glass filled (i.e. glass fibers) such as glass filed nylon for added strength.

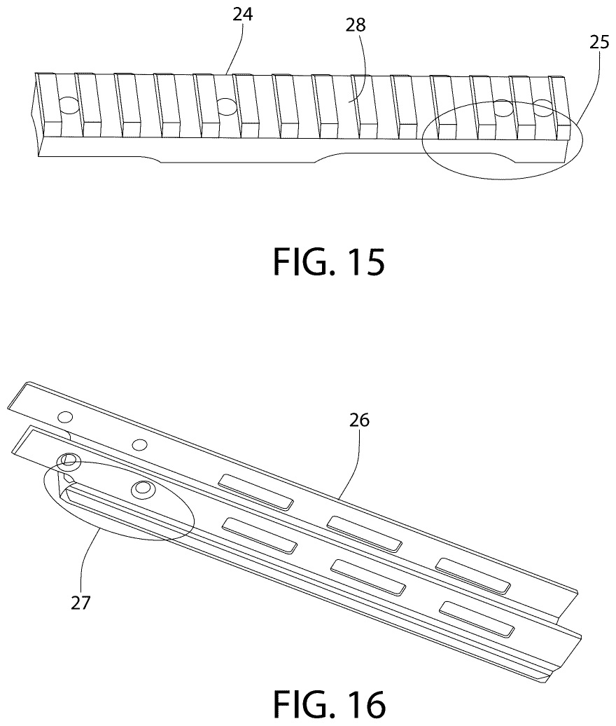

FIGS. 15 and 16 represent some additional firearm components that are subjected to high wear due to clamping forces when in use. FIG. 14 depicts a typical Picatinny style rail 24 that is mounted to a firearm to provide a stable platform to mount various firearm accessories like a scope, lights, laser sights, etc. This longitudinally elongated rail 24 is typically made from aluminum and undergoes wear due to the clamping forces applied when an accessory is slid onto and mounted to the rail with fasteners typically. The main area of wear (wear area) 25 is located around the edges of the horizontal cross grooves 28 that are located on the top of the rail 24. During the clamping and adjustment phase of attaching an accessory item to the rail 24, these edges 25 undergo significant clamping forces and wear occurs at the knife edge of the rail. According to the present disclosure, the entire rail 24 heretofore made of all metal may also now similarly be formed with reinforced polymer infused throughout the entire component body 100 with silicon dioxide round/spherical nanoparticles 8 for enhanced hardness and wear resistance to advantageously reduce weight of the component.

It bears noting that other types of accessory rails commonly used with firearms may also be formed of reinforced polymer infused throughout with silicon dioxide round/spherical nanoparticles 8 including for example without limitation M-LOK® Rails commercially-available from Magpul Industries Corp., ARCA rails 26 further described below, or other type accessory rails.

FIG. 16 is a depiction of a handguard 26 typically associated with bolt action rifles and semi-automatic rifles of various types. The handguard 26 allows the shooter to hold the weapon without contacting the hot barrel when firing and at least partially encircles the barrel similarly to handguard 55 shown in FIG. 7. The bottom of the handguard 26 in one embodiment contains a dovetail geometry commonly referred to as an ARCA rail 27 commonly also used in photography tripod mounts. As in the case of the Picatinny rail 24 mentioned earlier, the ARCA rail 27 is a longitudinally elongated dovetail type structure meant to create a mounting geometry for accessories that can slide forward and back along the longitudinal axis of the handguard 26 and firearm. This creates the same abrasive frictional loading conditions as the Picatinny rail 24 described above due to mechanical clamping forces and the sliding of the mount over the rail 27. This again is a part that is commonly made from a metallic structure due to the wear concerns of a polymeric material. The ARCA rail and handguard may now be formed of reinforced polymer infused throughout the component body 100 with silicon dioxide round/spherical nanoparticles 8 for enhanced hardness and wear resistance in order to reduce weight.

It bears noting that the types of firearm components or parts disclosed herein are just some non-limiting examples of the numerous types of firearm components that can benefit from nanoparticle infused polymers using silicon dioxide nanoparticles of either the flat platelet or round/spherical shape depending on the application. Firearm components formed of such a nanoparticle-polymer material offers the potential for firearm weight reduction especially when multiple traditionally high-wear components heretofore formed of metal are replaced with lighter weight nanoparticle impregnated polymers (fiber reinforced or unreinforced) are incorporated into a single firearm. This technology allows wear resistant polymer firearm components to be fabricated thereby eliminating the need for metal to address wear concerns.

Based on the foregoing example applications of a nanoparticle infused polymer for a component of a firearm, it bears noting that the nanoparticle infused polymer component may itself form the complete component as in the case of an entire pistol slide 20 for example formed of the polymer, or alternatively the nanoparticle infused polymer component may form only the portion or part of a firearm component which is subject to wear as in the case of the magazine throat insert with cartridge feed lips which in turn is coupled to the body of the magazine. Accordingly, the term “component” with respect to the component formed of nanoparticle infused polymer according to the present disclosure should be broadly construed to cover either of these two applications whether the component is the complete fully functional component or only part of a complete component that is not fully functional on its own.

Although embodiments of nanoparticle infused polymers according to the present disclosure may have been described in the context of firearm components, it will be appreciated that this technology may be used to replace metal components used in other industries and applications for various equipment and machinery where weight reduction and wear (e.g., abrasion) resistance may be beneficial such as various tools, automotive components, and numerous others. The invention described herein is therefore not limited to the field of firearms alone in its applicability which should be broadly construed.

### Example Embodiments

The following is a list of example embodiments and various combinations of features of the invention according to the present disclosure.

Embodiment 1. A wear resistant polymeric component for a firearm comprising: a body configured for use in the firearm in a position where at least a portion of the body will be subjected to abrasion; the body comprising polymer infused with a plurality of nanoparticles having a hardness greater than the polymer; wherein the nanoparticles comprise silicon dioxide.

Embodiment 2. The component according to Embodiment 1, wherein the polymer has a hardness of at least 4 on the Mohs hardness scale.

Embodiment 3. The component according to Embodiment 2, wherein the polymer comprises 10% by volume of nanoparticles.

Embodiment 4. The component according to any one of Embodiments 1-3, wherein the polymer is reinforced with fibers.

Embodiment 5. The component according to Embodiment 4, wherein the fibers are selected from the group consisting of carbon fibers, glass fibers, aramid fibers, and basalt fibers.

Embodiment 6. The component according to Embodiment 5, wherein the polymer comprises glass fiber filled nylon.

Embodiment 7. The component according to Embodiment 5, wherein the polymer comprises thermoplastic polyurethane.

Embodiment 8. The component according to any one of Embodiments 1-7, wherein the nanoparticles have a particle size in the range from about and including 10 nanometers to about and including 100 nanometers.

Embodiment 9. The component according to Embodiment 8, wherein the particle size of the nanoparticles is about 30 nanometers.

Embodiment 10. The component according to Embodiment 8 or 9, wherein the nanoparticles have a spherical form.

Embodiment 11. The component according to any one of Embodiments 1-10, wherein the nanoparticles are dispersed throughout an entirety of the body.

Embodiment 12. The component according to Embodiment 11, wherein the body has a substantially uniform distribution of nanoparticles such that the body has a substantially uniform hardness.

Embodiment 13. The component according to any one of Embodiments 1-12, wherein the nanoparticles are covalently bonded to chains of the polymer.

Embodiment 14. The component according to Embodiment 13, wherein the nanoparticles create physical bridges between polymer chains in the polymer.

Embodiment 15. The component according to any one of Embodiments 1-5, wherein the nanoparticles are flat nano platelets having a greater width than thickness.

Embodiment 16. The component according to Embodiment 15, wherein the nano platelets have a width ranging from about and including 200 to 500 nanometers.

Embodiment 17. The component according to Embodiment 15 or 16, wherein the nano platelets are arranged in at least partially overlapping relationship such that there are no open gaps between at least a majority of the nano platelets.

Embodiment 18. The component according to any one of Embodiments 15-17, wherein the body of the component comprises a composite laminate structure comprising a laminate stack formed by a plurality of layers bonded together.

Embodiment 19. The component according to any one of Embodiments 15-18, wherein the nano platelets are concentrated in a wear region of the body occupying a volume less than a total volume of the body of the component.

Embodiment 20. The component according to Embodiment 19, wherein the nano platelets are disposed in an outermost layer of the laminate stack defining a wear layer forming an exposed wear surface, the wear layer having a thickness less than a total thickness of the component.

Embodiment 21. The component according to Embodiment 20, wherein the wear layer and exposed wear surface thereof have a substantially uniform distribution of nano platelets such that the wear layer has a substantially uniform hardness.

Embodiment 22. The component according to any one of Embodiments 1-21, wherein the component is selected from the group consisting of a slide for a pistol, feed lips for an ammunition magazine, a throat insert comprising feed lips for an ammunition magazine, an accessory rail, a handguard, a firearm barrel, and a bolt for a firearm.

Embodiment 23. The component according to Embodiment 11, wherein the body is formed by injection molding or 3D printing.

Embodiment 24. The component according to Embodiment 2 or 3, wherein the body is configured for coupling to a second firearm component usable in the firearm which does not contain nanoparticles.

Embodiment 25. The component according to Embodiment 24, wherein the second firearm component is formed of metal.

Embodiment 26. The component according to Embodiment 17, wherein there are no open gaps between the nano platelets forming an outer hardened skeletonized wear structure.

Embodiment 27. A method for forming a composite polymeric component for a firearm with wear resistant properties, the method comprising: forming a base layer comprising a prepreg comprising reinforcing fibers embedded in a partially cured polymer matrix; forming one or more additional layers on the base layer, the one or more additional layers each comprising a prepreg comprising reinforcing fibers embedded in a partially cured polymer matrix; the base layer and one or more additional layers collectively forming a laminate stack; wherein an outermost layer of the one or more additional layers is infused with silicon dioxide nanoparticles to form an exposed hardened wear surface; and curing the laminate stack to form the component for the firearm.

Embodiment 28. The method according to Embodiment 27, wherein the nanoparticles are flat nano platelets having a greater width than thickness.

Embodiment 29. The method according to Embodiment 28, wherein the nano platelets have a width ranging from about and including 200 to 500 nanometers.

Embodiment 30. The method according to Embodiment 28 or 29, wherein there are no open gaps between the nano platelets forming an outer hardened skeletonized wear structure.

Embodiment 31. The method according to any one of Embodiments 27-30, wherein the polymer comprises 10% by volume of nanoparticles.

Embodiment 32. The method according to any one of Embodiments 27-31, wherein the outermost layer infused with the silicon dioxide nanoparticles has a hardness of at least 4 on the Mohs hardness scale.

Embodiment 33. The method according to any one of Embodiments 27-32, wherein the step of curing the laminate stack includes heating the laminate stack which hardens the laminate stack to form a rigid composite structure.

Embodiment 34. The method according to any one of Embodiments 27-33, wherein only the outermost layer is infused with the silicon dioxide nano platelets.

Embodiment 35. The method according to any one of Embodiments 27-34, wherein the base layer is formed on an underlying metal base to which the base layer is bonded during the curing step, the metal base forming an integral part of the firearm component.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

1. A wear resistant polymeric component for a firearm comprising:
a body configured for use in the firearm in a position where at least a portion of the body will be subjected to abrasion;
the body comprising polymer infused with a plurality of nanoparticles having a hardness greater than the polymer;
wherein the nanoparticles comprise silicon dioxide.

2. The component according to claim 1, wherein the polymer has a hardness of at least 4 on the Mohs hardness scale.

3. The component according to claim 2, wherein the polymer comprises 10% by volume of nanoparticles.

4. The component according to claim 1, wherein the polymer is reinforced with fibers.

5. The component according to claim 4, wherein the fibers are selected from the group consisting of carbon fibers, glass fibers, aramid fibers, and basalt fibers.

6. The component according to claim 5, wherein the polymer comprises glass fiber filled nylon.

7. The component according to claim 5, wherein the polymer comprises thermoplastic polyurethane.

8. The component according to claim 1, wherein the nanoparticles have a particle size in the range from about and including 10 nanometers to about and including 100 nanometers.

9. The component according to claim 8, wherein the particle size of the nanoparticles is about 30 nanometers.

10. The component according to claim 8, wherein the nanoparticles have a spherical form.

11. The component according to claim 1, wherein the nanoparticles are dispersed throughout an entirety of the body.

12. The component according to claim 11, wherein the body has a substantially uniform distribution of nanoparticles such that the body has a substantially uniform hardness.

13. The component according to claim 1, wherein the nanoparticles are covalently bonded to chains of the polymer.

14. The component according to claim 13, wherein the nanoparticles create physical bridges between polymer chains in the polymer.

15. The component according to claim 2, wherein the nanoparticles are flat nano platelets having a greater width than thickness.

16. The component according to claim 15, wherein the nano platelets have a width ranging from about and including 200 to 500 nanometers.

17. The component according to claim 15, wherein the nano platelets are arranged in at least partially overlapping relationship such that there are no open gaps between at least a majority of the nano platelets.

18. The component according to claim 17, wherein the body of the component comprises a composite laminate structure comprising a laminate stack formed by a plurality of layers bonded together.

19. The component according to claim 18, wherein the nano platelets are concentrated in a wear region of the body occupying a volume less than a total volume of the body of the component.

20. The component according to claim 19, wherein the nano platelets are disposed in an outermost layer of the laminate stack defining a wear layer forming an exposed wear surface, the wear layer having a thickness less than a total thickness of the component.

21. The component according to claim 20, wherein the wear layer and exposed wear surface thereof have a substantially uniform distribution of nano platelets such that the wear layer has a substantially uniform hardness.

22. The component according to claim 1, wherein the component is selected from the group consisting of a slide for a pistol, feed lips for an ammunition magazine, a throat insert comprising feed lips for an ammunition magazine, an accessory rail, a handguard, a firearm barrel, and a bolt for a firearm.

23. The component according to claim 11, wherein the body is formed by injection molding or 3D printing.

24. The component according to claim 2, wherein the body is configured for coupling to a second firearm component usable in the firearm which does not contain nanoparticles.

25. The component according to claim 24, wherein the second component is formed of metal.

26. The component according to claim 17, wherein there are no open gaps between the nano platelets forming an outer hardened skeletonized wear structure.

27-35. (canceled)
